(19) United States
(12) Patent Application Publication
(10) Pub. No.: US 2011/0187894 A1
(43) Pub. Date: Aug. 4, 2011

(54) RECORDING APPARATUS AND METHOD

(75) Inventors: Naru Hamada, Tokyo (JP); Keiichi Inoue, Tokyo (JP); Hirofumi Honda, Machida-shi (JP); Toshinori Koba, Kawasaki-shi (JP); Koji Ogaki, Koza-gun (JP)

(73) Assignee: CANON KABUSHIKI KAISHA, Tokyo (JP)

(21) Appl. No.: 13/013,474

(22) Filed: Jan. 25, 2011

(30) Foreign Application Priority Data
Feb. 3, 2010 (JP) 2010-022522

(51) Int. Cl. H04N 5/907

(52) U.S. Cl. 348/231.1; 348/E17.002

(57) ABSTRACT

A recording apparatus records data in a recording medium which has a plurality of blocks and includes an alternative block for a defect block, in accordance with a recording unit of a set data amount. The recording apparatus sets the data amount of the recording unit based on an alternative block remaining amount in the recording medium.

### BACKGROUND OF THE INVENTION

1. Field of the Invention

The present invention relates to a recording apparatus and method that records data in a recording medium having a flash memory.

2. Description of the Related Art

Conventionally, video cameras are known as recording apparatuses that record moving images and audio to recording media. More recently, video cameras that record moving images and audio to a large capacity flash memory or a memory card incorporating a flash memory have appeared.

A flash memory writes and reads out data in units called blocks. There are cases, however, where a defect block in which data cannot be written normally may occur during the manufacturing process or due to a later cause. To address this, a part of the memory is prepared for use as alternative blocks for such a defect block, and data that was supposed to be recorded to the defect block is written to an alternative block (see, for example, Japanese Patent Laid-Open No. 2002-109895).

However, even when a part of the flash memory is prepared for use as the alternative blocks, if a defect block is encountered after these alternative blocks have been used up, normal data writing is not possible, causing a writing error. In particular, when such a situation occurs during the writing of file system information to close a file, the file cannot be closed, and there is a possibility that not only that file but also all files recorded in the memory up to that point may not be able to be read out.

### SUMMARY OF THE INVENTION

The present invention has been made in view of the above-described problems, and an embodiment of the present invention provides a recording apparatus and method that can more reliably perform normal data recording in a recording medium having alternative blocks.

According to one aspect of the present invention, there is provided a recording apparatus comprising: recording means configured to record data in a recording medium having a plurality of blocks, including an alternative block for a defect block, in accordance with a recording unit of a set data amount; and a setting unit configured to set the data amount of the recording unit based on an alternative block remaining amount in the recording medium.

According to another aspect of the present invention, there is provided a recording method comprising the steps of: recording data to a recording medium having a plurality of blocks including an alternative block for a defect block by using a set data amount as a recording unit; and setting the data amount of the recording unit based on an alternative block remaining amount in the recording medium.

Further features of the present invention will become apparent from the following description of exemplary embodiments with reference to the attached drawings.

### BRIEF DESCRIPTION OF THE DRAWINGS

FIG. 1 is a block diagram showing an example of a configuration of a video camera according to an embodiment of the present invention.

FIG. 2 is a block diagram showing an example of a configuration of a recording medium according to the embodiment of the present invention.

FIG. 3 is a flowchart illustrating recording medium mounting processing.

FIG. 4 is a flowchart illustrating determination processing for determining whether or not recording is possible.

FIG. 5 is a flowchart illustrating writing unit setting processing.

FIG. 6 is a flowchart illustrating recording processing.

### DESCRIPTION OF THE EMBODIMENTS

Hereinafter, an example of a preferred embodiment of the present invention will be described with reference to the accompanying drawings.

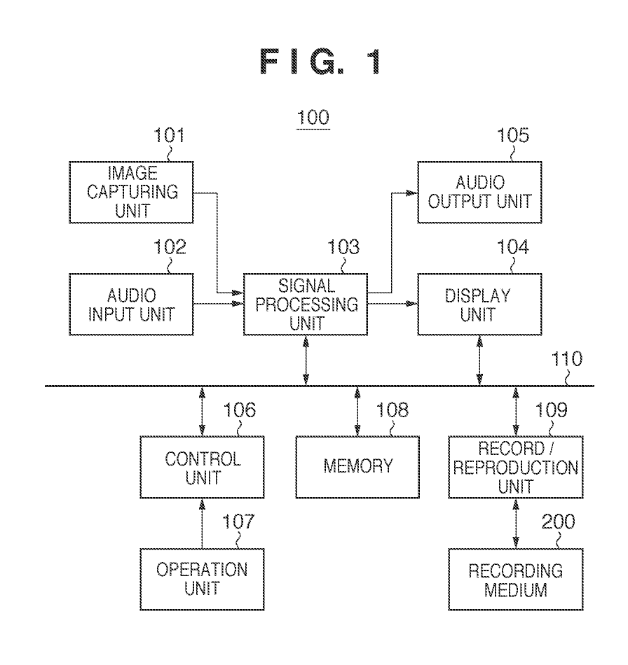

FIG. 1 is a block diagram showing an example of a configuration of a video camera 100 as a data recording apparatus according to an embodiment of the present invention. An image capturing unit 101 captures images of an object and outputs moving image data that is input over time to a signal processing unit 103. An audio input unit 102 has a microphone, and outputs audio data that is input over time to the signal processing unit 103. The signal processing unit 103, when recording, performs necessary processing such as compression, encoding and the like according to a predetermined encoding method such as MPEG, on the moving image data from the image capturing unit 101 and the audio data from the audio input unit 102. When in reproducing mode, the signal processing unit 103 decodes reproduced moving image data and audio data. A display unit 104 displays captured moving images from the signal processing unit 103 when recording and displays reproduced moving images when reproducing. Furthermore, the display unit 104 also displays information necessary for user operations such as a menu. An audio output unit 105 has a speaker, and outputs an audio signal from the signal processing unit 103.

A control unit 106 has a microcomputer, a memory and the like, and controls various constituent units of the video camera 100. An operation unit 107 has a power switch, a switch for issuing instructions to start and stop recording, a switch for switching to a reproduction mode, a menu switch, and the like. The user can issue instructions to execute various operations and functions to the video camera 100 through operation of any of the switches of the operation unit 107. A memory 108 has an SDRAM or the like, and stores compressed moving image data, audio data, and other necessary data. The memory 108 also functions as a buffer memory when recording or reproducing data to or from a recording medium 200. A record/reproduction unit 109 writes or reads out data to or from the recording medium 200 in accordance with an instruction from the control unit 106. The recording medium 200 is a recording medium capable of random access, and is a memory card incorporating a NAND flash memory in the present embodiment. The recording medium 200 can be easily attached to and detached from the video camera 100 by the user with an attachment/detachment mechanism (not shown). A bus 110 transmits data and various commands between the blocks.

In the present embodiment, the control unit 106 manages information data, such as moving images and audio, recorded in the recording medium 200 as a file in accordance with a specific file system such as FAT (File Allocation Table) file system. Accordingly, in addition to the information file in which information data is stored, file system information for managing the recorded file is recorded to the recording medium 200. The file system information recorded in the recording medium 200 is updated along with information file recording processing. The record/reproduction unit 109 may have a configuration corresponding to a general-purpose interface such as ATA (Advanced Technology Attachment). In this case, the control unit 106 controls writing and readout of data to and from the recording medium 200 by outputting a command defined by the general-purpose interface to the record/reproduction unit 109.

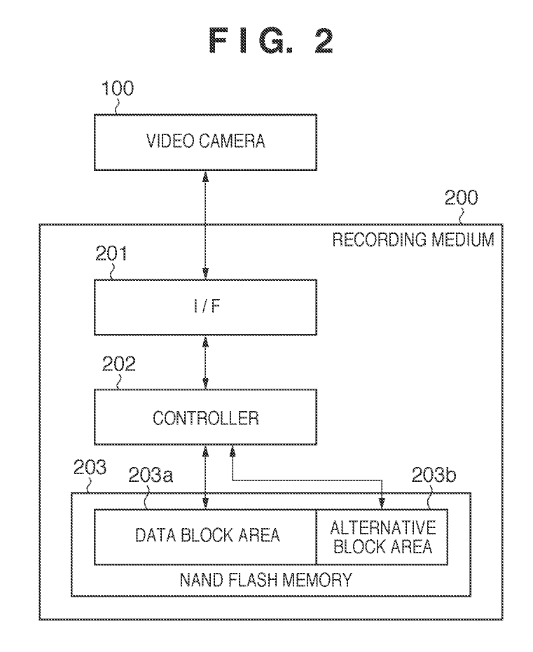

Next, the recording medium 200 will be described. FIG. 2 is a block diagram showing a configuration of the recording medium 200. As shown in FIG. 2, the recording medium 200 has an interface (I/F) 201 that transmits and receives data and commands to and from a recording apparatus such as the video camera 100, a controller 202, and a NAND flash memory 203 serving as a storage unit. The recording medium 200 is capable of writing data into the flash memory 203 in blocks, each consisting of a plurality of bytes, and is configured such that a part of all blocks is utilized as alternative blocks for defect blocks in which data cannot be written normally. In other words, the flash memory 203 has a data block area 203a and an alternative block area 203b for defect blocks in the data block area 203a. In the present embodiment, a predetermined physical address area in the flash memory 203 has been allocated in advance as the alternative block area 203b.

In FIG. 2, the interface (I/F) 201 transmits and receives commands and data to and from the record/reproduction unit 109 of the video camera 100. The controller 202 controls writing or readout of data to or from the flash memory 203 in response to a command received by the I/F 201. For example, upon receiving a write request command from the record/reproduction unit 109, the controller 202 receives data to be written from the record/reproduction unit 109 and writes the data to the data block area 203a. If writing has been completed normally, the controller 202 generates a writing result as a response, and transmits the response to the record/reproduction unit 109 via the I/F 201.

If the writing of data to the data block area 203a is not completed within a predetermined period of time, the controller 202 determines that a defect block has occurred, and writes the data to an unused block in the alternative block area 203b instead of the defect block. The controller 202 then changes an address map (not shown) contained in the flash memory 203 so as to replace the address of the defect block with the address of the alternative block. Furthermore, the controller 202 generates a response indicating a writing error, and transmits the response to the record/reproduction unit 109 via the I/F 201. Upon finding a defect block(s), the controller 202 writes information regarding the position and the number of defect blocks that have been found, and so on, to a system management area in the data block area 203a. In other words, the controller 202 allocates an address (physical address) in the flash memory 203 to an address (logical address) designated by an external device, and generates an address map indicating correspondences between logical addresses and physical addresses. Then, when a defect block occurs, the controller 202 changes the address map so as to allocate the physical address of an alternative block to the designated logical address. The controller 202 saves the address map in the data block area 203a.

If the alternative blocks in the alternative block area 203b have been used up, the controller 202 writes information indicating that the recording medium is a reproduction-only (read-only) recording medium to the system management area in the data block area 203a. By doing so, the controller 202 can transmit a response indicating that the recording medium is for reproduction only when a query for the operational state of the recording medium 200 is received from a host device such as the video camera 100.

In the present embodiment, as will be described later, the controller 202 detects the alternative block remaining amount in the alternative block area 203b when a request to transmit available remaining amount (the number of unused alternative blocks) in the alternative block area is received from the video camera 100. Then, the controller 202 notifies the record/reproduction unit 109 of information indicating the alternative block remaining amount via the I/F 201.

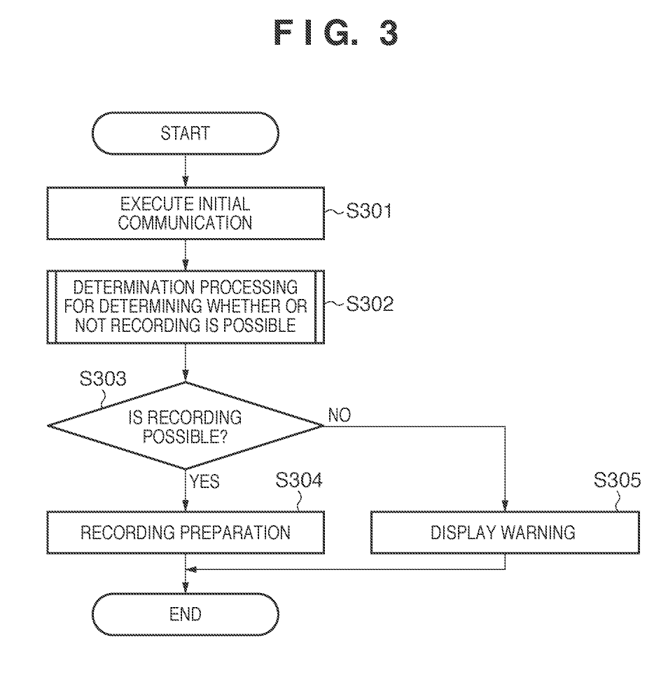

Next, a description of recording preparation (mounting) processing for the recording medium 200 performed when the recording medium 200 is attached and when the power of the video camera 100 is turned on will be given. FIG. 3 is a flowchart illustrating the mounting processing. The processing shown in FIG. 3 is executed by the control unit 106 controlling various units. The control unit 106 may have a processor and a memory (not shown), and a configuration that executes predetermined processing by the processor executing a program stored in the memory.

When the power of the video camera 100 is turned on, the record/reproduction unit 109 determines whether the recording medium 200 is attached, and if the recording medium 200 is attached, the record/reproduction unit 109 so notifies the control unit 106. Also, if the record/reproduction unit 109 detects that the recording medium 200 has been newly attached while the power of the video camera 100 is on, the record/reproduction unit 109 so notifies the control unit 106. The control unit 106 starts the mounting processing shown in FIG. 3 when the record/reproduction unit 109 notifies that the recording medium 200 is attached upon power-on of the video camera 100 or when the record/reproduction unit 109 detects that the recording medium 200 has been newly attached as described above.

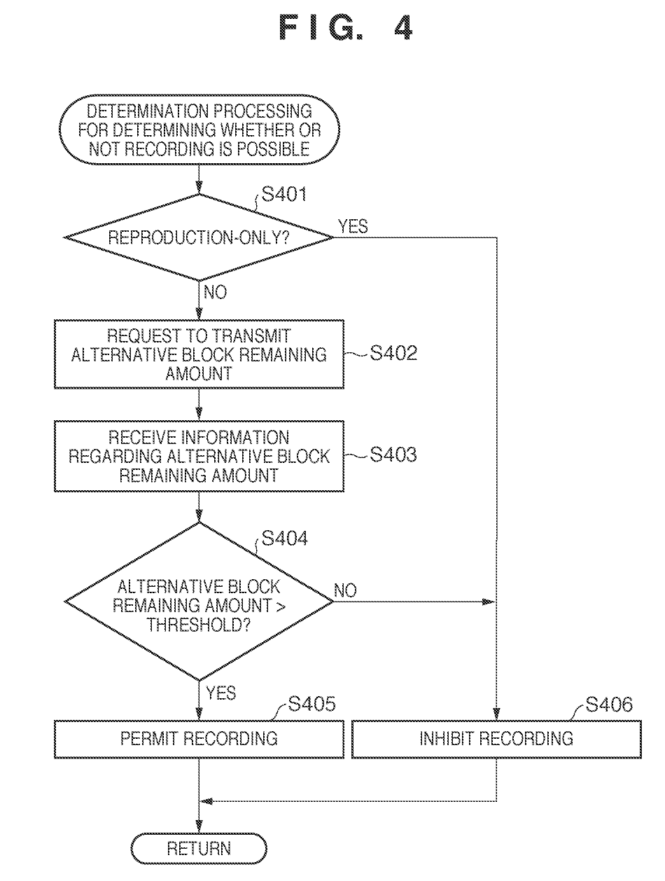

Firstly, the control unit 106 executes initial communication (S301). In the initial communication, the control unit 106 resets the controller 202 of the recording medium 200, and receives register information of the recording medium 200 necessary to record data from the recording medium 200. Next, the control unit 106 executes, prior to the start of recording to the recording medium 200, determination processing for determining whether recording of data to the recording medium 200 is possible in accordance with the obtained register information (S302). The determination processing will be described later in detail with reference to FIG. 4. If it is determined that recording is possible (S303), the control unit 106 executes recording preparation processing (S304). Specifically, the control unit 106 reads out file system information from the recording medium 200, stores the file system information in the memory 108, and analyzes the content of the file system information. Then, the control unit 106 obtains information necessary for recording such as the remaining recording capacity of the recording medium 200. Also, the control unit 106 checks the files recorded in the recording medium 200, and searches for a file that can be managed by the video camera 100. As will be described later, the control unit 106 sets a writing unit for recording moving image data based on the alternative block remaining amount in the recording medium 200. As used herein, the writing unit is the amount of data written into the flash memory 203 with a single write request command, or in other words, a recording unit, and is the amount of data corresponding to a predetermined number of blocks. The recording medium 200 writes a writing unit of data transmitted following the write request command into the flash memory 203. At this time, if a defect block in which writing has failed is detected, the recording medium 200 writes the data in an unused block in the alternative block area 203b instead of the defect block. If, on the other hand, it is determined in S303 that recording is not possible, the control unit 106 displays warning information indicating that data recording is not possible to the recording medium 200 on the display unit 104, and terminates the mounting processing without performing recording preparation processing.

Next, the determination processing (the processing of S302) for determining whether or not recording is possible that is performed in the processing for mounting the recording medium 200 will be described. FIG. 4 is a flowchart illustrating the determination processing for determining whether or not recording is possible. In FIG. 4, firstly, the control unit 106 reads out register information recorded in the recording medium 200 via the record/reproduction unit 109, and determines whether the recording medium 200 is for reproduction only (S401). If it is determined that the recording medium 200 is for reproduction only, writing of data is not possible to the recording medium 200, and therefore the control unit 106 inhibits recording to the recording medium 200, and indicates as such on the display unit 104 (S406).

If, on the other hand, it is determined in S401 that the recording medium 200 is not for reproduction only, the control unit 106 requests the recording medium 200 to transmit information regarding the alternative block remaining amount (S402). Upon receiving the request for information regarding the alternative block remaining amount from the video camera 100, the controller 202 detects the remaining amount of the alternative block area 203b, and transmits information indicating the remaining amount of the alternative block area 203b to the record/reproduction unit 109. The record/reproduction unit 109 receives the information indicating the alternative block remaining amount, and transmits the information to the control unit 106 (S403).

Next, upon receiving the information indicating the alternative block remaining amount, the control unit 106 compares the alternative block remaining amount with a threshold, and determines whether the alternative block remaining amount is larger than the threshold (S404). If the result of comparison indicates that the alternative block remaining amount (the number of remaining alternative blocks) is larger than the threshold, the control unit 106 permits recording of moving image data to the recording medium 200 (S405). If the alternative block remaining amount is less than or equal to the threshold, the control unit 106 inhibits recording to the recording medium 200, and displays warning information indicating this fact on the display unit 104 (S406). The threshold used here will be described later.

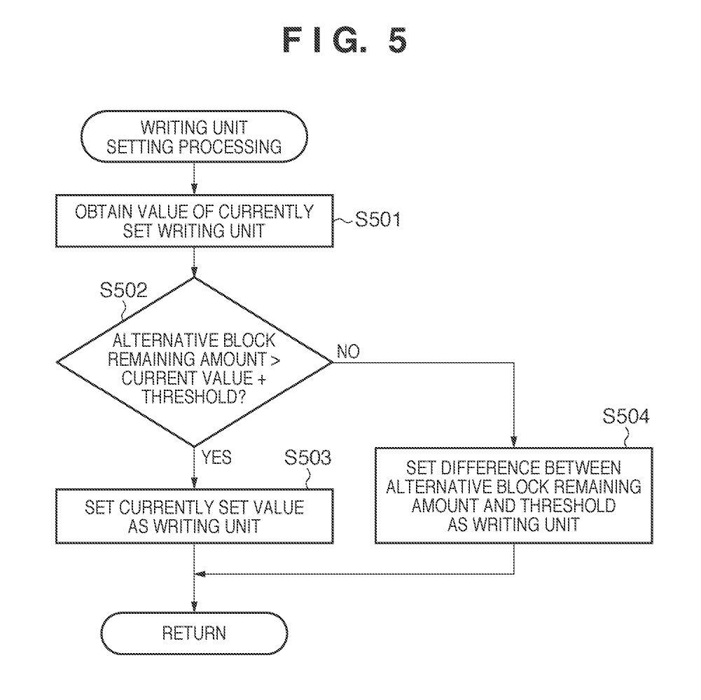

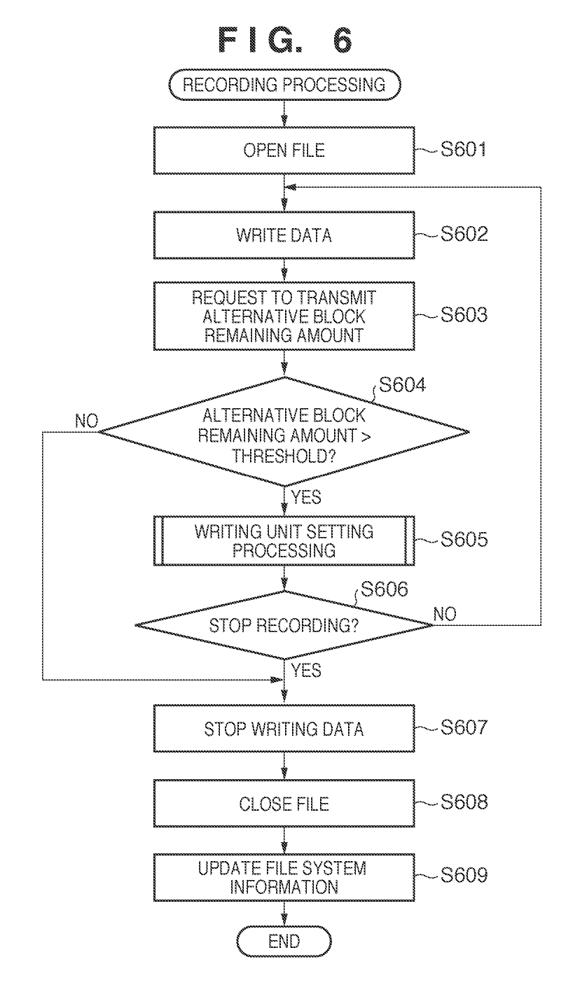

Next, writing unit setting processing that is one step of the recording preparation of S304 described above will be described with reference to the flowchart shown in FIG. 5. The processing of FIG. 5 is executed by the control unit 106 controlling various units. The processing of FIG. 5 is also executed during moving image data recording processing (FIG. 6), in addition to the recording preparation processing (S304) in FIG. 3.

In the present embodiment, when recording moving images, captured moving image data and input audio data are temporarily stored in the memory 108. When a predetermined amount of moving image data and audio data corresponding to a writing unit is stored in the memory 108, the control unit 106 reads out the data from the memory 108, and writes the data into the recording medium 200. In other words, over a period of time the data input is written into a data file in the flash memory in steps of a predetermined amount. In the present embodiment, the rate at which data can be written into the recording medium 200 is higher than the rate of the moving image data and audio data output from the signal processing unit 103. Accordingly, writing of data to the recording medium 200 is performed intermittently. The memory 108 functions as a buffer memory for such intermittent recording. Specifically, when the amount of moving image data and audio data stored in the memory 108 corresponds to a set writing unit, the control unit 106 starts writing the data to the recording medium 200. When writing of the data of the writing unit is complete, the control unit 106 stops data writing to the recording medium 200. By repeating the writing of data per writing unit in this manner, data is intermittently written. In the writing unit setting of the present embodiment, the amount of data per writing unit for use in writing data is adjusted to decrease in response to a decrease in the alternative block remaining amount. The amount of data per writing unit and the alternative block remaining amount may be expressed in numbers of blocks.

Firstly, the control unit 106 reads out and obtains a value of the data amount currently set as a writing unit for writing data as described above from an internal register provided in the control unit 106 (S501). In the case where the writing unit setting processing is executed in the recording preparation processing of S304, the preset initial value is obtained as the amount of data per writing unit. Next, the control unit 106 compares the alternative block remaining amount obtained from the recording medium 200 with the sum of the amount of data per writing unit obtained in S501 and the threshold (S502). If the alternative block remaining amount is larger than the sum of the currently set writing unit and the threshold, the control unit 106 sets the currently set writing unit as the amount of data per writing unit (S503). If, on the other hand, it is determined in S502 that the alternative block remaining amount is less than or equal to the sum of the currently set writing unit and the threshold, the control unit 106 newly sets the difference between the alternative block remaining amount and the threshold as the amount of data per writing unit (S504). The control unit 106 controls the record/reproduction unit 109 so as to record moving image data by using the data amount that has been set in the manner described above as a writing unit.

Next, the threshold used in FIGS. 4 and 5 will be described. In the present embodiment, the threshold is set such that when updating the file system information recorded in the recording medium 200, even if the blocks that record the file system information are all defect blocks, the file system information can be updated by using alternative blocks. The amount of data needed to update the file system information when closing a file is, in the case of FAT32, the sum of a block capacity needed to write a file entry and a block capacity needed to update the FAT. For example, where the size needed to update the FAT and file entry is assumed to be 4 mega bytes (MB), if the alternative block remaining amount is 4 MB or more when closing the file, the file system information can be updated normally. Here, if the size of one block in the recording medium 200 is assumed to be 2 MB, the number of alternative blocks needed to update the file system information will be two. It should be noted that the size of one block of 2 MB is merely exemplary, and the present invention is not limited thereto. In this manner, in the present embodiment, the alternative block remaining amount needed to update management information (file system information) for managing a file in accordance with a specific file system is set as the threshold.

Next, a single writing unit of moving image data in FIG. 5 will be described. For example, if the alternative block remaining amount is larger than the total of a single writing unit of data and the size of file system information, the single writing unit of data to be written next can be written into alternative blocks even if the blocks designated as a place into which the data is to be written are all defect blocks. In addition, even if recording is stopped at that time and the file is closed, alternative blocks needed to update the file system information will be secured.

Here, if the size of one writing unit is reduced, the loss of alternative blocks can be reduced, enabling more efficient use of the recording medium (improving the efficiency of utilization of the recording medium 200). However, reducing the size of the writing unit increases the frequency of access to the recording medium 200, encroaching on the bandwidth of the bus 110. If, on the other hand, the size of one writing unit is increased, the frequency of issuance of write instructions from the control unit 106 to the record/reproduction unit 109 can be decreased, enabling efficient use of the bandwidth of the bus 110, but a memory having a large capacity is required as a buffer memory. Also, the loss of utilization of alternative blocks will increase (the efficiency of utilization of the recording medium 200 will decrease). This is because if, for example, the writing unit is x blocks, and y blocks are necessary to record management information, writing of subsequent data is inhibited at the time when the writing of alternative block remaining amount becomes less than or equal to x+y−1 blocks.

Accordingly, in the present embodiment, the initial value of the writing unit is set taking the efficiency of utilization of the recording medium 200, the bandwidth of the bus 110, the cost of the memory 108, and the like into account. The initial value is set as the writing unit while the alternative block remaining amount is larger than the sum of the initial value and the threshold needed to update the file system information as described above. When the alternative block remaining amount becomes less than or equal to the sum of the initial value of the writing unit and the threshold due to writing of moving image data, the writing unit is reset to a smaller data amount without changing the threshold, and thereby the recording medium 200 can be used efficiently. Specifically, when the alternative block remaining amount becomes less than or equal to the sum of the amount of data per writing unit and the threshold, the difference between the alternative block remaining amount and the threshold is newly set as the amount of data per writing unit.

Next, recording processing will be described. FIG. 6 is a flowchart illustrating recording processing of the video camera 100. The processing shown in FIG. 6 is executed by the control unit 106 controlling various units.

The processing shown in FIG. 6 starts when the user issues an instruction to start recording through operation of the operation unit 107. Firstly, the control unit 106 performs file open processing for opening a moving image file for storing captured moving image data and input audio data (S601). In this processing, the control unit 106 determines the file name, and registers the file information thereof in the file system information stored in the memory 108.

Also, the control unit 106 controls the signal processing unit 103 so as to compress the moving image data from the image capturing unit 101 and the audio data from the audio input unit 102, and stores the compressed moving image data and audio data in the memory 108. Then, when a predetermined amount of moving image data and audio data corresponding to a writing unit is stored in the memory 108, the control unit 106 reads out the data from the memory 108, and writes the data into the recording medium 200 (S602). The recording medium 200 is controlled such that if a defect block is detected during the writing operation, the data that is supposed to be written into the defect block is written into an alternative block.

When writing of data per writing unit is complete, the control unit 106 sends a request to the recording medium 200 to transmit the remaining amount of alternative blocks (S603). The controller 202 of the recording medium 200 detects the alternative block remaining amount in the alternative block area 203b, and transmits information indicating the alternative block remaining amount in the manner described above. The control unit 106 compares the alternative block remaining amount received from the recording medium 200 with the threshold needed to update the file system information (S604). If the alternative block remaining amount is larger than the threshold, the control unit 106 executes writing unit setting processing shown in FIG. 5 (S605).

After the writing unit has been set, the control unit 106 continues writing, and waits for an instruction to stop recording from the user. If the user issues an instruction to stop recording through operation of the operation unit 107 (S606), the control unit 106 stops storing new moving image data and audio data in the memory 108. Then, the control unit 106 writes the data stored in the memory 108 into the recording medium 200, and thereafter stops writing (S607). Subsequently, the control unit 106 closes the currently recorded file (S608), changes the content of the file system information stored in the memory 108, and writes the file system information into the recording medium 200, thereby updating the file system information (S609).

If, on the other hand, it is determined in S604 that the alternative block remaining amount is less than or equal to the threshold, the control unit 106 stops writing data to the recording medium 200 without waiting for a user's instruction to stop recording (S607), and closes the currently recorded file (S608). Then, the control unit 106 changes the content of the file system information stored in the memory 108, and writes the file system information into the recording medium 200, thereby updating the file system information (S609). When the number of remaining alternative blocks becomes less than or equal to the number of blocks needed to record management information for managing the file system in this way, recording of data is automatically stopped. Accordingly, files are always closed with the amount of alternative blocks needed to record management information for managing a file system being secured.

Next, reproduction processing will be described. Upon receiving an instruction for a reproduction mode from the operation unit 107, the control unit 106 controls the record/reproduction unit 109 so as to read out each moving image file recorded in the recording medium 200 and output the moving image file to the signal processing unit 103. The signal processing unit 103 decodes the first image of each moving image file, generates a representative image for each moving image file by using the first image, and displays a list of representative images on the display unit 104.

When the user selects a desired representative image from the list of representative images, and issues an instruction to start reproduction, the control unit 106 instructs the record/reproduction unit 109 so as to reproduce the moving image file corresponding to the selected representative image. The record/reproduction unit 109 reproduces the selected moving image file from the recording medium 200, and outputs the moving image file to the signal processing unit 103. The signal processing unit 103 decodes the moving image data and audio data of the reproduced moving image file, and outputs the moving image data and audio data to the display unit 104 and the audio output unit 105, respectively. The control unit 106 stops reproduction of the moving image file when it receives an instruction to stop reproduction.

In this manner, according to the present embodiment, a threshold is set based on the amount of data needed to update the file system information and the amount of data per writing unit, and if the alternative block remaining amount in the recording medium 200 reaches the threshold, recording is stopped. Accordingly, it is possible to reliably update the file system information, normally record the recorded data, and reproduce the data.

In the present embodiment, the value of the single writing unit of data is changed based on the alternative block remaining amount. Accordingly, the recording medium can be efficiently utilized.

In the present embodiment, in FIG. 6, a query for the state of alternative blocks is made to the recording medium 200 each time writing of one writing unit of data is complete, but the present invention is not limited thereto. It is possible to, for example, make a query before writing of one writing unit of data starts, and change the amount of data per writing unit as needed.

Also, when the alternative block remaining amount is significantly larger than the sum of the writing unit and the threshold, the interval between the processing for querying the recording medium 200 for the alternative block remaining amount performed in S603 and the writing unit setting processing performed in S605 may be increased. For example, the following configuration may be used: when the difference between “alternative block remaining amount” and “the sum of writing unit and threshold” exceeds a first threshold, the processing spanning from S603 to S605 is executed once in ten times of writing operation. Then, when the difference between “alternative block remaining amount” and “the sum of writing unit and threshold” becomes less than or equal to the first threshold, the processing spanning from S603 to S605 is executed for each writing unit.

Furthermore, the embodiment described above illustrated the configuration in which the writing unit is adjusted in S405 of FIG. 4 and S605 of FIG. 6 so that alternative blocks can be utilized more efficiently. However, it is also possible to employ a configuration without adjustment of the writing unit from the viewpoint of securing update of management information for a specific file system when closing a file. In this case, in FIG. 6, S605 is omitted, and in S604, “the number of blocks needed for management information (threshold)+the number of blocks corresponding to the writing unit” and “alternative block remaining amount (the number of remaining blocks)” are compared. Then, if “the number of blocks needed for management information (threshold)+the number of blocks corresponding to the writing unit”>“alternative block remaining amount (the number of remaining blocks)”, the processing branches to S607, where the writing of data is stopped.

When adjusting the writing unit in S605, a lower limit value (a block number of two or more) may be provided for a data amount that can be set as the writing unit, in relation to the bandwidth of the bus 110 described above. For example, if the lower limit value is set to 3 blocks, the minimum writing unit that can be set in the writing unit setting processing will be 3 blocks. In this case, in S604, the processing needs to branch to S607 at the time when the alternative block remaining amount becomes less than or equal to “the number of blocks needed to record management information+2 blocks”. In this case, the determination processing in S604 branches to S607 if “the number of blocks needed to record management information (threshold)+2 blocks”>“alternative block remaining amount”. To put it more generally taking the above variation into account, the determination processing of S604 branches to S607 if “the number of blocks needed to record management information (threshold)+the minimum number of blocks that can be set as the writing unit”>“alternative block remaining amount”.

As can be seen from the description of the embodiment given above, in S604, a determination is made as to whether or not alternative blocks corresponding to the number of blocks needed to record management information are secured even if the writing unit of data transmitted next consumes all defect blocks. In other words, if it is determined in S604 of FIG. 6 that “the amount of data per writing unit (the minimum value that can be set by adjustment in case adjustment is possible)+threshold (the number of blocks needed to record management information)”>“alternative block remaining amount”, writing of subsequent data is stopped.

Also, if there is information, other than the file system information, that needs to be updated along with recording of moving image data such as information for managing the order of reproduction of recorded data, the threshold may be set based on the size of the management information (including the file system information).

The present embodiment has been described in the context of the recording medium 200 having a configuration capable of being attached to and detached from the video camera 100. Besides this configuration, it is also possible to employ a configuration in which a recording medium containing a flash memory is incorporated in the video camera body, and the present invention is also applicable to such a configuration. Also, the data that can be written into the recording medium 200 is not limited to moving image data and audio data that are input from the image capturing unit 101 and the audio input unit 102, and may be, for example, a broadcast signal or stream data delivered over the web.

As described above, according to the present invention, the presence of alternative blocks is secured to update file system management information, and therefore normal recording of data to the recording medium is secured.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-022522, filed on Feb. 3, 2010, which is hereby incorporated by reference herein in its entirety.

What is claimed is:

1. A recording apparatus comprising:
recording means configured to record data in a recording medium having a plurality of blocks, including an alternative block for a defect block, in accordance with a recording unit of a set data amount; and
a setting unit configured to set the data amount of the recording unit based on an alternative block remaining amount in the recording medium.

2. The apparatus according to claim 1, further comprising:
a management unit configured to manage the data recorded in the recording medium in accordance with a predetermined file system,
wherein the recording means records file system information for managing a file containing the data in accordance with the predetermined file system in the recording medium, and
the setting unit sets a data amount needed to update the file system information recorded in the recording medium as a threshold, and sets the data amount of the recording unit based on the threshold and the alternative block remaining amount.

3. The apparatus according to claim 2,
wherein if the alternative block remaining amount is larger than a sum of a previously set data amount and the threshold, the setting unit sets the previously set data amount as the data amount of the recording unit.

4. The apparatus according to claim 3,
wherein if the alternative block remaining amount is less than or equal to the sum of the previously set data amount and the threshold, the setting unit sets a difference between the alternative block remaining amount and the threshold as the data amount of the recording unit.

5. The apparatus according to claim 2, further comprising:
a control unit configured to control the recording means so as to stop recording of the information data if the alternative block remaining amount reaches the threshold during recording of the information data, and thereafter record the file system information in the recording medium.

6. The apparatus according to claim 5,
wherein the recording medium includes a storage unit configured to have the plurality of blocks and a controller configured to control writing and readout of data to and from the storage unit,
the setting unit obtains information regarding the alternative block remaining amount in the storage unit via the controller, and sets the data amount of the recording unit based on the obtained information regarding the alternative block remaining amount in the storage unit, and
the control unit controls the recording means so as to stop recording of the data if the obtained alternative block remaining amount reaches the threshold.

7. The apparatus according to claim 1, further comprising:
a unit configured to input data to be recorded in the recording medium; and
a memory configured to store the input information data,
wherein the recording means reads out the data from the memory and records the data in the recording medium in response to the data in an amount corresponding to the set recording unit being stored in the memory.

8. A recording method comprising the steps of:
recording data to a recording medium having a plurality of blocks including an alternative block for a defect block by using a set data amount as a recording unit; and
setting the data amount of the recording unit based on an alternative block remaining amount in the recording medium.
